(19) United States
(12) Patent Application Publication
(10) Pub. No.: US 2024/0398669 A1
(43) Pub. Date: Dec. 5, 2024

(54) CONTAINER WITH ADJUSTABLE AND VARIABLE FLOW FROM A NURSING OR RELATED BOTTLE INTEGRALLY INCORPORATING WITHIN ITS NIPPLE A NECESSARY VENTING THAT PREVENTS LEAKING AND ALLOWS FOR CONTROLLED DISPENSING OF THE BOTTLE FORMULA DURING USAGE AND APPLICATION

(71) Applicant: Craig Brown, Shelbyville, IL (US)

(72) Inventor: Craig Brown, Shelbyville, IL (US)

(73) Assignee: Truvents, LLC, Shelbyville, IL (US)

(21) Appl. No.: 18/326,627

(22) Filed: May 31, 2023

(51) Int. Cl. A61J 11/02; A61J 11/04

(52) U.S. Cl. CPC A61J 11/02; A61J 11/04

(57) ABSTRACT

Any container, but especially a nursing bottle formed of a container, incorporating a unique nipple, where the flow can be infinitely adjusted by turning the bottle on it's longitudinal axis, and which flows freely, without any negative pressure within the container, at all times, simulating normal physiological feeding pressures, without leaking. The nursing bottle may have a cylindrical shape or other configuration. The nipple uniquely utilizes a venting mechanism that provides a pathway for air entrained from the threads of the bottle to proceed to the interior of the container without liquid leaking from the bottle. No additional parts are needed, and any existing traditional container may be utilized, which reduces cost, cleaning steps, and the time needed to feed and clean up.

### CROSS-REFERENCE TO RELATED APPLICATIONS

This application claims priority to provisional patent application 63/473,497 and is related to the patent application having Ser. No. 16/350,274, filed on Oct. 25, 2018. That application is a continuation-in-part of the letters patent application having Ser. No. 14/544,773, filed on Feb. 18, 2015, now U.S. Pat. No. 10,149,800, which latter application claims priority to a provisional patent application having Ser. No. 61/966,292, filed on Feb. 18, 2014; this application is a continuation-in-part of application having Ser. No. 29/793,074, filed Apr. 5, 2021. And this application is a continuation-in-part of the design application having Ser. No. 29/620,662, filed on Apr. 11, 2017, which latter application is a continuation-in-part of the design application having Ser. No. 29/505,428, filed on Oct. 29, 2015, now abandoned; and this patent application claims priority as a continuation-in-part of the design patent application having Ser. No. 29/620,663, filed on Apr. 10, 2017; and the latter application claims priority as a continuation-in-part of the patent application having Ser. No. 29/474,759, filed on Jan. 29, 2015, now abandoned; and this patent application claims priority as a continuation-in-part of the design patent application having Ser. No. 29/620,664, filed on Apr. 11, 2017, and which latter application claims priority as a continuation-in-part upon the design patent application having Ser. No. 29/505,029, filed on Apr. 30, 2015, which latter application is now abandoned.

This application is a continuation-in-part of application having Ser. No. 29/742,356, filed on Oct. 13, 2020; this application is also a continuation-in-part of application having Ser. No. 63/372,296, filed on Mar. 1, 2022.

### FEDERALLY SPONSORED RESEARCH AND DEVELOPMENT

This invention was not made with government support. The government has no rights in the invention.

### JOINT RESEARCH AGREEMENT

None.

### REFERENCE TO A “SEQUENCE LISTING”, A TABLE, OR A COMPUTER PROGRAM LISTING APPENDIX SUBMITTTED ON A COMPACT DISC AND AN INCORPORATION-BY-REFERENCE OF THE MATERIAL ON THE COMPACT DISC

None.

### PRIOR ART

Other U.S. patents that relate to the subject matter of this invention include the U.S. patent to Briere, U.S. Pat. Nos. 189,691; 345,518, to Lelievre; U.S. Pat. No. 679,144, to Hardesty; U.S. Pat. No. 834,014, to Lyke; U.S. Pat. No. 1,600,804 to Donaldson; U.S. Pat. No. 2,156,313, and to U.S. Pat. No. 2,239,275 Schwab; U.S. Pat. No. 2,610,755, to Gits; U.S. Pat. No. 2,742,168, to Panetti; U.S. Pat. No. 2,744,696, to Blackstone; U.S. Pat. No. 3,059,707, to Wilkinson, et al; U.S. Pat. No. 5,570,796, to Brown, et al. In addition British patents No. 273,185 and No. 454,053 show related developments.

### BACKGROUND OF THE INVENTION

Newborns and older infants are in need of sustenance in the form of calories, hydration, vitamins, and minerals. Initially, infants require feeding every two to four hours and occasionally more often. Traditionally, breast-feeding has supplied the aforementioned sustenance. Babies have the instinct to suckle milk from their mothers. However, at times, breast milk is inadequate, does not appear, or the infant's mother lacks the ability to breastfeed her infant. Also, other factors may interfere with the infant receiving adequate hydration and nutrition. An infant may be premature or have anatomical changes that may interfere with feeding, such as a cleft lip or palate, or have developmental changes that preclude adequate breastfeeding.

For a variety of reasons, caregivers often either supplement breastfeeding with feeding containers or use feeding containers exclusively. Babies lack the ability to drink from ordinary glasses and cups without spilling. So, liquids are fed to babies using baby or nursing bottles. A nursing bottle neck typically features a nipple made of silicone, latex, rubber or other material with a hole in its tip and is secured across an opening in the top of the nursing bottle.

The currently available nursing bottle is used by filling the bottle or bag with a liquid, sometimes inserting a structure to attempt venting, securing the nipple, inverting the bottle, and placing the nipple into the baby's mouth. The baby then consumes the liquid in the container.

Early on, inventors created closed containers to assist feeding infants. The original version of today's feeding devices consisted solely of a container with a pliable end that was nipple shaped. With this arrangement, instant and significant negative pressure instantly builds within the interior, or inner space, of the container. An analogous situation occurs when an individual ascends in an airplane and the pressure in the middle ear fails to equalize as the pressure decreases within the airplane, causing a significant amount of ear pain. In a baby bottle, an analogous large vacuum forms, which means that a larger negative pressure has to form intraorally in order to withdraw the feeding liquid from the bottle. This is basically identical to the pressure that forms when infants suck on their thumbs or pacifier, and when airplane travel causes ear pain. All of these pressures have been shown to contribute to the formation of ear fluid, ear infections, speech and motor delay, and delayed cognitive development.

Venting claims are frequently made by bottle manufacturers, and the vast majority of the prior art claims to supply venting through the flange of the nipple. However, negative pressure steadily builds, when used, due to the slit in the flange not opening. The flanges are designed and manufactured to be thick, in order to provide sealing and prevent tearing. The prior air containers typically have one or more slits cut into the flange of the nipple. The flange of the nipple is designed to provide sealing and cannot physically vent, as they would also leak, with the prior art designs. Flow cannot be controlled by the infant, with these containers, since liquid is not free to exit, and nonphysiological and unhealthy feeding patterns are reinforced for the infant. With these containers, an infant cannot easily obtain nutrition or control the flow of the fluid, and must constantly fight against the unhealthy, unphysiological negative pressure that increases during each suck. These negative pressures are the opposite pressures that occur with breastfeeding since, with breastfeeding, liquid is free to exit the breast, which is very frequently demonstrated when women have to use breast pads between breast pumping intervals, and also breastfeeding sessions.

For free flow to occur, both initial and subsequent neutral or positive pressure must be present. Otherwise, the infant will be trying to overcome a negative pressure, or vacuum, which is the opposite pressure of the breast. The presentation of the milk to the infant or pump at the nipple is, by definition, physiological mammary intraductal pressure. Studies have repeatedly shown that breastfeeding is the ideal method to supply sustenance to infants. Promoting optimal breastfeeding involves presenting milk to the infant with the same intraductal physiological pressure. Unvented and under-vented containers are nonphysiological and unhealthy, which will be discussed below.

Flow impediments, such as the very significantly detrimental vacuum and lack of feeding control, are demonstrated when the nipple on a standard feeding container is simply cut in half and the bottle is inverted, into the feeding position. No liquid will exit, due to the vacuum present, unless a very significant vacuum is exerted on the nipple, in which case, only very few drops of liquid may be removed, and only if the intraoral pressure is greater than the instant vacuum formed in the bottle, or air is introduced, as with the current invention, to relieve the vacuum formation. The above vacuum, in unvented and under-vented bottles, is significant, and physiologically detrimental, since it will remain in the container indefinitely, even with the nipple cut completely in half, until the vacuum is relieved.

The typical current art is tightly sealed, but for the opening in the feeding end of the nipple. The claimed venting slot, or hole, in the flange of the nipple, the bottom of the container, or other locations on the bottle, typically, on both measurement and usage, results in no venting, or rarely, extremely significant underventing. This is explained by the fact that if a part of a container has a simple slit in flexible material, which is typically the case in the bottles currently available, fluid will leak from the container prior to any venting of the container if the slit is too wide, or will not vent, if the material is too thick. Manufacturers make the small slits and utilize thick flange material to claim venting but, as mentioned above, leakage or no venting will occur with that arrangement. On the unusual occasion that slight venting occurs with a check-valve arrangement on the nipple flange, a significant vacuum quickly forms, with its unhealthy and nonphysiological detrimental effects, due to significant initial underventing, followed by no venting. Also, this type of valve is difficult or impossible to clean, and quickly deforms and leaks with usage.

In bottles, except the past art of the inventor and the current invention, the volume of liquid in the bottle decreases and the vacuum in the bottle increases proportionally, as the liquid in the bottle is consumed. The past art of the inventor and the current invention, move air into the container to replace the vacuum formed and allows ambient air to enter the bottle, while the baby suckles, in order to automatically and continuously vent the container. The current art improves the flow of liquid out of the nipple and makes it easier for the baby to suckle.

The negative pressures, or vacuums, in the current art of unvented, partially-vented, and bag-containing systems is not physiological, but instead are mechanical shortcomings that can cause significant infant morbidity. It is well known that breastfeeding involves positive and neutral pressures within the breast. These pressures have been measured by inserting canulas into breast ducts.

A type of feeding container using a collapsible bag has been introduced, but is messy, expensive, and provides a negative feeding pressure during usage, while consuming the last two ounces of feeding liquid. A feeding container from Offman, U.S. Pat. No. 5,449,098, with a vent in the side of the neck of the bottle has been introduced, but it's design prevents cleaning and it's reservoir leaks.

Frequently, as mentioned above, containers have a nipple with one or more simple slits in the flange of the nipple, which, if they opened to allow air in, would allow liquid to leak out of the container. Other containers have a soft diaphragm in various parts of the container, again stating that the slit in the soft material, used as a diaphragm, will allow air in without allowing liquid to leak out of the bottle. These also, obviously, don't open, since the material used is very thick and shaped to not open with any amount of pressure.

Prior art favors preventing leakage from feeding containers, without regard for venting the container. Therefore, the valves provided are thick, small, and don't typically open. Following the laws of physics, in the prior art containers, except for those of the current inventor, valve edges impede opening of the valve or forcefully adhere to each other, when negative pressure is applied to the valve.

Also, if the valve remained even very slightly open, liquid leaks through the valve and subsequently from the bottle, and has to be cleaned up. In the prior art containers, while claiming venting at the level of the flange of the nipple, the valves are purposely made thick, to prevent leaking. The structure of the prior art valves is such that their stiffness prevents flexing and opening to allow air in to relieve the vacuum that forms during attempted usage.

The current invention utilizes air entry into the container to prevent liquid leakage from the container, utilizing a unique valve with a large differential thickness gradient along with a proportionally small valve surface area, that ensures that liquid does not exit the feeding system, and air preferentially enters the container.

With undervented and unvented containers, air must be introduced into the container for the fluid to exit. Since the valves don't open, air can only enter when the infant can't withdraw liquid from the container and releases the container from the mouth. At that time, air enters the container through the small hole in the tip of the nipple that is designated for egress of the feeding liquid. As a large vacuum is formed with the prior art, detrimental health effects are noted, and no significant fluid release or control of fluid release is possible.

The prior art also introduced flap valves, which are vertically oriented flaps, when the bottle is in the upright position, and formed by opposing pieces of material that are designed to open one way and open easily to negative pressure. Due to their design, these valves rarely open, and if they do, they require a very significant negative pressure to open. With the few drops of liquid that may exit, due to the instant and drastic negative pressure encountered with traditional feeding containers, no actual flow of liquid occurs, so the infant, again, cannot have any control of feeding. A variation of this is a wavy or other patterned shape to the flange, which deforms back to its planar shape when the collar of the container is tightened. The undulation is best noted when the flange is viewed perpendicularly to the observer. This type of prior art rarely vents, and when it does, it only occurs very minimally, nonphysiologically, and was very similar to no venting at all. If this type of wavy pattern persists while tightening the nipple onto the bottle, leakage occurs. Another variation is where a thick diaphragm is placed in the bottom of the feeding container, which contains a slit. Again, this type of valve doesn't open, due to the thickness of the material.

Currently, other nursing bottles, except the current invention, are available in many different types. Some require several additional, expensive parts that must be cleaned and accounted for. Certain of these containers vent, as is evidenced by the free flow of liquid during usage. Others either don't vent, partially vent, or utilize expensive, environmentally unfriendly bags that must be collapsed toward the end of the feeding, causing a negative intraoral pressure, with the typical transfer of that detrimental negative pressure into the ears, with untoward side-effects.

Caregivers, traditionally, if the current invention or functional added parts aren't present, have resorted to unscrewing the collar that fastens the nipple flange to the collar of the feeding bottle, to attempt to vent the container and allow some fluid to exit the container. With even a very slight loosening of the nipple attachment to the feeding container, very significant leakage is noted, which is especially disappointing if the feeding contains difficult-to-obtain breast milk.

Traditional feeding container manufacturers claim to have small, medium and large-sized liquid exit apertures in the distal end of the feeding nipple, for infants of various sizes and ages. Upon measurement of these, very frequently, the hole sizes are not uniform among nipples that are packaged to have the same-size liquid aperture. Also, of note, is that very frequently, nipples don't differ in aperture size uniformly from one another, as labeled, so there is physically no different flow, and slow, medium, and fast speeds are physically not present. These factors, especially when added to the very significant instant vacuum present in the feeding container, with each suck, means that infants not only don't get any significant flow, but the few drops obtained are not physiological, are not controllable by the infant, or caregiver, and that all of these factors are cumulatively detrimental to the infant's health.

As above, infants feed against a nonphysiological negative pressure unless functioning venting is truly accomplished. Some manufacturers started producing messy, expensive collapsible bag systems that require increasingly negative pressure to keep collapsing the bag to remove the liquid.

Breast anatomy consists of glands that produce milk and ducts that easily carry the milk from the glands to the nipple. The milk comes from the breast with a positive or neutral pressure, which is why women wear breast pads, in order to catch any milk flow between feedings or between pumping sessions. Thus, with the pressure in the breast neutral or positive, it is typically easy for the infant to get milk from the breast with little effort, with the breast pad catching the milk flow between sucking or pumping.

Infants learn to physiologically control the flow from the breast. Infants can easily control the flow of the milk, since it is coming out freely. Milk is easily expressed and physiologically increasing milk production occurs over time.

The breast tissue responds to the increasing demand of an infants, as they grow and learn ideal sucking patterns, by increasing the production of milk. Breast glands also gradually change the composition of the milk with regard to both calories and components, as the infant continues to breastfeed.

When infants breastfeed, they control the flow of milk from the breast with their tongue and mouth. They can increase the positive pressure peristaltic motion of the tongue from the proximal breast to the distal nipple to increase the flow of milk. Also, they can generate more suction in the mouth by contracting the facial muscles and tongue around the nipple. Subsequently, the infant moves the jaw inferiorly and the tongue backward, increasing the intraoral volume and creating a vacuum.

When an infant wants to increase the flow of milk, they increase both the peristaltic frequency and pressure with the tongue on breast tissue, going from a proximal breast to a distal nipple direction. They will also generate more suction in the mouth by increasingly contracting the facial muscles and the tongue around the nipple, as well as increasingly moving the jaw inferiorly and the tongue further backward.

When an infant wants to decrease the flow of milk, they will decrease both the peristaltic frequency and pressure of the tongue on breast tissue, still going from a proximal breast to a distal nipple direction.

They will also generate less suction in the mouth by decreasing the contractions of the facial muscles and the tongue around the nipple, and also decrease the inferior movement of the jaw and the posterior tongue motion.

All of the above changes in the infant sucking patterns and pressures, as well as the milk production by the breast, are well documented and consistent. It is also well known that breast milk is the ideal food for infants and breastfeeding helps promote bonding between infants and mothers. However, breastfeeding rates have traditionally been low for multiple reasons, and caregivers have increasingly relied on feeding containers, to supply either breast milk or formula to infants.

The above physiological mechanisms involved in breastfeeding consist of positive and negative feedback loops and are extremely sensitive. Any significant changes in feeding physiology that alters infant sucking patterns, milk flow patterns, or intraoral pressure generation, in any way, slows and decreases infant feeding. By altering these feeding patterns, the infant doesn't empty the milk glands and ducts completely, milk production slows, and may eventually stop.

A very significant factor that contributes to slowing milk production is the change of intraoral physiology that occurs when switching back-and-forth between physiological free-flowing breast milk from the breast and prior-art unvented or undervented containers. Closed, undervented and unvented containers are unphysiological and breastfeeding is physiological.

Frequently, for a variety of reasons, infants go between breastfeeding and feeding from a container. The easy, controllable flow of milk from the breast and the increasingly negative pressure in most prior art containers, which inhibit feeding, are opposite, and infants very frequently develop “nipple confusion.” During the “confusion,” infants develop significant feeding problems, milk productions drops precipitously, and sometimes stops. As above, the infant and the breast tissue, ducts, and nipple work in concert to deliver as much milk as the infant requires for sustenance, and to deliver it in the most efficient method possible.

If the feeding physiology between the breast and feeding container isn't very similar, the breast will continue to reduce it's production of milk, again, to the detriment of the infant.

Since prior art containers, except for the few that use extra parts and also function physiologically, don't flow physiologically and form a negative pressure in the container, the flow of liquid cannot be controlled by the caregiver or infant. All of these factors increase infant morbidity, increase nipple confusion, and decrease breastfeeding rates.

### SUMMARY OF THE INVENTION

The feeding bottle with infinitely adjustable flow and full-time, complete and automatic venting, with no additional parts, relates generally to infant serving products. More specifically, the present invention refers to any container that assists any infant, including a premature infant, to suck liquid, at at desired rate, from the container. The current invention, in it's assembled form, may consist of two or more components, and it may be applied to any type of container.

A unique aspect of the present invention is the elimination of additional parts to the container, while providing physiological, full, automatic, and continuous venting, when any liquid is withdrawn from the container, while preventing leakage from the container, which allows adjustable flow from the nipple by both the infant and caregiver. The unique nipple construction cooperates with the neck and threads of the container, and fully vents the feeding container, while preventing leakage from the container. The present invention also includes a unique pathway for the flow of air from threads of the container, to the surface of the flange of the container, to the unique one-way valve in the flange of the nipple.

Since narrow-neck containers have a uniform diameter neck, where the nipple is held onto the container of fluid, one standard size nipple can typically be used on existing commercial fluid containers. The necks of wide-neck containers vary slightly in size, but a small variety of nipple flange diameters will fit the vast majority of current feeding wide-neck containers. Thus, with the current invention, individuals will typically need to only purchase one or more nipples for any number of narrow-neck containers during the span of time the infant is feeding from a bottle, and can reuse the collars and bottles that that they current may have. With an embodiment of the current invention, only the current invention and feeding bottle are needed, and a collar to attach the nipple to the feeding bottle isn't needed. Caregivers don't need to purchase messy, expensive bags or extra parts that vent or attempt to vent the container, in order to achieve physiological flow. With the current invention, caregivers can change the flow by simply rotating the bottle and the infant can use their tongue to manipulate the apertures of the feeding nipple, which is analogous to physiology they use with breastfeeding.

The ideal flow from a feeding bottle simulates the flow from the breast. This flow is physiological and the healthy way to feed infants. During breastfeeding, the infant and caregiver both control the flow continuously, during the entire feeding. This flow, which is the optimum method for feeding infants, can only be achieved by providing a flow that is completely adjustable by both the infant and caregiver.

That physiological and healthy control of the flow requires two components. The liquid must come out of the container easily, like from the breast. If the liquid doesn't flow easily, increasing and decreasing the rate of flow is not possible. Secondly, once the liquid is free-flowing, the apertures through with the liquid flows, must be adjustable by both the infant and the caregiver. To obtain a ideal physiologically adjustable flow, which comprises the ideal and easy egress of the liquid from the container, as occurs with the breast, these apertures must allow the infant and caregiver to control the flow from the container.

As above, breast milk flows easily. Frequently, when the infant releases from the breast or the mother takes the breast out of the infant's mouth, the milk continues to flow, and the affected surfaces have to be cleaned. The flow from the current invention stops as soon as the baby stop sucking on the bottle, preventing leakage from the nipple, retaining collar, and bottle assembly.

Previously, the Applicants have introduced a vented container using a venting tube and reservoir formed in two pieces. The Applicants' prior inventions consist of a feeding container and a venting mechanism, with extra parts, that provides for venting. Other applications, requiring fluid removal from a container without the antagonistic effects of a vacuum, can benefit from a fully vented container, which provides for the egress of fluid at a desired rate.

Many other attempts have been made to provide a nursing bottle with an air vent to reduce the creation of a vacuum during suckling. An early patent to Roderick, U.S. Pat. No. 598,231 has a nursing bottle with a U shaped tube. However, the average baby, upon uplifting a bottle, had some liquid retained in the U shaped tube. The retained liquid blocked the tube and prevented ambient air from releasing any vacuum within the bottle. Other patents show related types of technology, and provide means for venting air from the interior of a container, as can be seen in the Van Cleave, U.S. Pat. No. 927,013. In addition, the Davenport, U.S. Pat. No. 1,441,623 and to Perry, U.S. Pat. No. 2,061,477, show other means for venting air from within a nursing bottle. In the preceding work of these applicants, U.S. Pat. Nos. 5,779,071 and 5,570,796, venting and internal tubes prevent the formation of partial vacuums during suckling and also resisted spills. The '071 patent provides a venting tube that extends into a bottle and a reservoir. The venting tube has a hollow cylindrical shape projecting sufficiently downwardly into the bottle. The '796 patent provides a reservoir located above a mark on the bottle. The reservoir communicates with a conduit system to replace suckled liquid with air from the exterior of the feeding container by allowing air to enter the reservoir and to travel to the bottom of the container, preventing a partial vacuum in the bottle when in the feeding position.

Nursing bottles of a multitude of designs are available in the prior art. In all instances, except for the patented devices of the inventor and the current invention, a vacuum will be generated within the bottle during usage, as when feeding an infant. A vacuum, particularly a large vacuum, is known to cause various physiological impairments to the infant when they are subjected to this nonphysiological condition. The vacuum generated within an undervented, and especially unvented bottle, due to absent venting in the prior art, makes the infant generate a very high negative and nonphysiological pressure in the oral cavity to try to withdraw fluid from the container. This very significant negative pressure in the oral cavity is transferred up their eustachian tubes, which are connected to the oral cavity. This pressure is then transferred to the middle ears.

As the middle ears are increasingly subjected to this negative pressure, serous, clear fluid is drawn into the middle ears. This fluid frequently results in decreased hearing and speech delays. The fluid can also get infected, resulting in “glue ear,” and even more severe complications may result, such as middle ear bone destruction and permanent hearing loss.

It is well known that this degree of negative pressure may even cause deformation of other oral components, such as the shape of the palate, shape of the face, and cause malalignment of the teeth, all of which can lead to other health problems. Repetitive, or chronic ear infections have been tied to motor delay, developmental delay, and other impairments. Thus, the presenting of a nursing bottle that incorporates air venting means, so as to prevent the creation of a vacuum inside the bottle, has been considered a desirable development in the field of infant serving products.

Such can be seen in the inventor's prior patents '071 and '769, when the feeding bottle is inverted, or in the feeding position, external air enters around the threads of the bottle, into the insert, into the reservoir tube, through the venting tube to the bottom of the bottle, thereby completely eliminating all vacuum.

The current invention provides means for venting of any vacuum within any feeding, or other container, whether angled, straight, wide neck or other shape, and to prevent the generation of any vacuum, or negative pressure therein, regardless whether the nursing bottle is being used when partially or fully inverted as during consumption of its contents.

Other U.S. patents that relate to the subject matter of this invention include the U.S. patent to Briere, U.S. Pat. Nos. 189,691; 345,518, to Lelievre; U.S. Pat. No. 679,144, to Hardesty; U.S. Pat. No. 834,014, to Lyke; U.S. Pat. No. 1,600,804 to Donaldson; U.S. Pat. No. 2,156,313, and to U.S. Pat. No. 2,239,275 Schwab; U.S. Pat. No. 2,610,755, to Gits; U.S. Pat. No. 2,742,168, to Panetti; U.S. Pat. No. 2,744,696, to Blackstone; U.S. Pat. No. 3,059,707, to Wilkinson, et al; U.S. Pat. No. 5,570,796, to Brown, et al. In addition British patents No. 273,185 and No. 454,053 show related developments.

Nevertheless, the prior art containers and methods suffer from significant disadvantages, except for the inventions of the Applicant. Such disadvantages include:
1. The formation of a vacuum that prevents oral feeding by infants with cerebral palsy, cleft lip, cleft palate, and other feeding difficulties.
2. The formation of a vacuum within a container that prevents or delays premature infants from going home promptly when the premature infants have a poor sucking reflex or require weaning from a feeding tube.
3. The formation of vacuum within a container that prevents or suppresses close bonding contact between caregivers and premature infants that have a poor sucking reflex or require weaning from a feeding tube.
4. The formation of vacuum within a container that prolongs hospitalization and increases costs for premature infants that have a poor sucking reflex or require weaning from a feeding tube.
5. Manufacturing for prior art containers has a high cost for the components, including the container, vent parts, and collapsible bags.
6. Many past feeding systems utilize extra components, which add to the cost of the systems, require cleaning, and are frequently lost and must be replaced.
7. Because of cost, reusable feeding containers are used repeatedly, thus incurring significant usage costs, especially with regard to the additional costs associated with the processing, cleaning, sterilization and handling of the additional parts and bags of many feeding systems. Frequently, these additional parts are lost and must be replaced, also adding to the cost of using extra parts.
8. Since past feeding systems utilize their own proprietary parts, without the ability to use generic components, they are much more costly to purchase and maintain.
9. Since proprietary feeding systems vary considerably in thread and other size aspects, replacement of any components must come from the same company, and generic components can not be substituted for the original parts.
10. In some environments, such as hospitals, where many infants are present in one location and because of government rules and regulations, disposable bottles are frequently used, which is very costly for hospitals, and other institutions, especially when feeding containers use extra parts or use bags.
11. As infants require multiple feedings per day, repeated use of prior art feeding containers increases the incidence of an infant receiving a feeding container or component previously used by another infant or an ill infant, especially when containers are expensive and are frequently reused.
12. Because hospital staff, including nurses, try multiple different prior-art feeding containers, in an attempt to satisfactorily feed infants, the incidence rises of an infant receiving a feeding container previously used by another infant or an ill infant.
13. Also, the parents of an infant will likely try multiple different prior-art feeding containers, in an attempt to satisfactorily feed their infant, which again increases the incidence of their infant receiving a feeding container previously used in a hospital nursery by another well or ill infant.
14. Often, ill infants, with varying severity of illness, require feedings not just multiple times per day, but also multiple times per hour, which increases the possibility of contamination of one or more parts, when nondisposable containers are reused. The risk of contamination increases exponentially with the introduction of each new container part, especially since extra parts are typically small in size.
15. The prior art bottles, except those of the inventor, and the current invention, do not provide an internal vent system and mechanism for containing fluid inside the container, by venting on demand, and preventing the exit of feeding liquid during feeding. Therefore, the prior art bottles, except those of the inventor, including the current invention, either leak, prevent venting, use extra parts, or most frequently, a combination of these.
16. Parents, hospital staff, nurses, and relatives report that leakage from vent holes in prior art bottles, other than those of the inventor, and the current invention, causes problems.
17. When prior art bottles, except those of the current inventor, release feeding liquid, a vacuum, or negative pressure occurs in unvented or partially vented bottles.
18. Any vacuum existing in a prior art bottle, except those by the inventor, and the current invention, induces a vacuum in the intraoral cavity of an infant which spreads into the ears and leads to accumulation of ear fluid, ear infections, speech and motor delays, and cognitive delay, among other unhealthy maladies.
19. Prior art bottles, except those of the inventor, and the current invention, that cause a vacuum have a difficult and irregular release of the feeding liquid.
20. Vacuum formation in prior art bottles, except those of the inventor, and the current invention, prevents an infant from feeding on demand, which is the preferred method of feeding.
21. Further, vacuum formation prevents the use of a feeding container for liquid without a positive pressure source powered by a pump to overcome the negative pressure within prior art bottles, except expensive bag systems, those of the inventor, and the current invention. Such pumps burden parents and hospital staff with mechanical devices and a higher cost.
22. To overcome the vacuum in prior art closed containers, except those of the inventor, and the current invention, a hole can be placed in the body of the fluid filled container. The vent hole, particularly its location, creates a void through which feeding liquid readily escapes, or leaks, and contaminates the immediate area, along with decreasing the amount of feeding liquid remaining in the container.
23. In prior art bottles, except those of the inventor, and the current invention, precise release of feeding liquid doesn't occur, as the release is irregular, due to the steady rise of the negative pressure.
24. Additionally, closed slits placed to attempt venting in prior art containers, except those of the inventor, and the current invention, function only for leakage prevention, which is frequently unsuccessful, and prove difficult or impossible to keep clean, and thus foster contamination of the feeding liquid, and container, by bacterial growth.
25. Some prior art bottles, except for the current invention of the current inventor, utilize, in an attempt to vent, extra part(s) or unreachable surface(s), or both, which are impossible to clean. These parts and surfaces, except for the past art of the current inventor and the current invention of the inventor, do not function to prevent negative pressure formation in the container, and are unphysiological and unhealthy for the infant.
26. The prior art containers, except for those of the inventor and the current invention, don't provide for adjustable flow for the infant. The physics of the negative pressure formation in the container prevent the infant and/or caregiver from adjusting the flow at any time.

The present art overcomes the limitations of the prior art, that is, bottles that attempt, but fail, to vent through a closed slit in the flange of the nipple, or container, or utilize additional parts, which are messy and expensive, and have to be replaced, where a need exists for eliminating the vacuum inside nursing bottles and providing for adjustability of the flow.

That is, the art of the present invention, an automatically venting nipple that makes adjustable flow possible, eliminates the formation of a vacuum within a nursing bottle and allows both the infant and the caregiver to adjust the flow. The present invention cleans easily, is inexpensive to manufacture and endures inadvertent chewing. The present invention prevents leaks and continuously vents a bottle.

Additionally, the present invention presents the following advantages:
1. The elimination of vacuums fosters oral feeding by infants with cerebral palsy, cleft lip, cleft palate, and other feeding difficulties.
2. The elimination of a vacuum within a container cuts days off the time before premature infants, and all infants can go home, because they reinforce the proper sucking reflex and infants are weaned more quickly from a feeding tube.
3. The complete elimination of vacuum within a container fosters close bonding contact between caregivers and premature infants that have a poor sucking reflex or require weaning from a feeding tube, leading to happier infants.
4. The complete elimination of vacuum within a container shortens hospitalization and reduces costs for premature infants, since they can be weaned more quickly from a feeding tube.
5. Manufacturing for the present invention has a low cost for the components, and doesn't require any additional parts.
6. Because of the low cost, the components of the present invention are disposable, by the end-user, if desired. They may also be recycled.
7. In the hospital environment where infants receive care in groups, the inexpensive, fully-vented, infant feeding container of the present invention may be economically discarded or recycled following each feeding.
8. As infants require multiple feedings per day, and the present invention can be discarded or recycled, due to its low cost, the incidence of an infant receiving a feeding container previously used by another infant or an ill infant decreases very significantly.
9. Hospital staff, including nurses, have a variety of containers, some prepackaged with formula. The present invention allows use of any type of preferred formula with any type or shape of container.
10. The parents of an infant may have multiple containers, some prepackaged with formula, and are able to keep their infant on the preferred container, since the nipple is interchangeable with any container, which again decreases the incidence of an infant receiving a feeding container previously used by another infant in a hospital nursery or an ill infant.
11. The present invention does not call for reuse as a durable item because it can be discarded or recycled. Without repeated use, the incidence decreases of an infant receiving a feeding container previously used by another infant or an ill infant.
12. Often, ill infants with varying severity of illness, require feedings not just multiple times per day but also multiple times per hour, which the disposable and recyclable feature of the present invention supports and thus decreases contamination formerly caused by the reuse of bottles.
13. An automatic, continuous, and complete feeding mechanism is provided and a mechanism for containing fluids is included in the present invention. Also the container can be held in any position, with complete functioning of the venting system.
14. Parents, hospital staff, nurses, and relatives benefit from a marked reduction in leaks from bottles as the present invention is leak resistant.
15. When the present invention releases feeding liquid, no vacuum, or negative pressure occurs.
16. The lack of a vacuum within the present invention prevents the existence of a vacuum in the intraoral cavity of an infant, which decreases the incidence of accumulation of ear fluid, ear infections, speech and motor delays, and cognitive delay, among other maladies.
17. The present invention has easy and regular release of the feeding liquid to the infant, as a result of the absence of a vacuum.
18. The present invention, because there is no vacuum, encourages an infant to feed on demand, the preferred method of feeding.
19. Further, no pump is required when using the present invention, as no vacuum has to be overcome. Such pumps are a burden on parents and hospital staff and increase the cost of care.
20. The present invention provides for precise release of feeding liquid, as the release is regular, due to absence of a vacuum.
21. The present invention has no holes in the wall of the container as in some prior art containers, and no extra components, thereby making the container easier to clean and reducing the possibility of contaminating the feeding liquid with bacteria.
22. The present invention, with the advantages described, and avoiding the disadvantages of the prior art containers, except those of the inventor, provides infants and their caregivers a container for feeding liquid with virtually no leaks and no vacuum.
23. The present invention prevents leakage from the bottle when inverted, as this may occur with the prior art of the Inventor.
24. The present invention, as it is fully vented, allows for completely adjustable flow with typical usage, especially when utilized in the preferred configuration, with patterned slits extending radially from the distal aspect of the nipple. With simple rotation of the container, one obtains a slower or faster flow configuration, and both the infant and caregiver can completely control the flow of the container at all times, which is the physiological method of feeding.
25. Previously, infant feeding bottles, except those of the inventor, and the current invention, had a unvented, or partially vented container with the previously described disadvantages.
26. The lack of venting prevented any significant flow of liquid from the container, and thus no control of the flow by the infant. The cost of prior art bottles did not allow for easy disposal. The prior art bottles also served poorly in hospitals, where they were not physiological and posed health risks that typically increased infant morbidity.
27. The present invention provides for an economical container that permits full and continuous venting and full control of the flow, in a container of feeding liquid, and that completely eliminates formation of vacuum with the container.
28. The present invention allows for the ready flow of feeding liquid, as demanded by the infant, without leaks from the container.
29. The present invention provides a feeding container that fosters normal oral, ear, respiratory, and digestive physiology; and encourages hygienic nutrition, along with optimizing the feeding abilities of all infants.
30. Additionally, the present invention impedes any leakage from the bottle, with it's unique valve with a large differential thickness gradient utilizing a proportionally small valve surface area, that ensures that liquid does not exit the feeding system, and air preferentially enters the container.
31. Leakage from wide-nipple compression is prevented by the large differential thickness gradient. Also, leakage is prevented with heating of the formula, or other liquid, by the large differential thickness gradient.

The various sizes are typically arranged in a clockwise or counterclockwise pattern, in order to allow the caregiver to easily rotate the combination of feeding nipple, any collar used, and fluid container. A symbol is typically embossed or debossed adjacent to one, or more, of the flow rates, so the caregiver can easily and quickly feel, even in the dark, the feeding speed that the infant is going to receive. Infants typically feed at different speeds at different times of the day, usually faster in the morning and slower at night, so the caregiver can easily use the current invention on the feeding container, and rotate the bottle, nipple, and any fastening collar, in unison, to the desired speed.

This is economical, as it requires fewer parts to be both purchased and used. Also, fewer parts have to kept on-hand, cleaned, and replaced. A typical example of an embossed or debossed symbol is a symbol of a drop, which is adjacent the slow flow. When the symbol is at the 12:00 position, the flow may be slow. When it is at the 4:00 position, the flow may be medium, and when it is at the 8:00 position, the flow may be fast. Also, one symbol may be adjacent the slow flow position of the nipple, two near the medium flow position of the nipple, and three near the fast flow position of the nipple.

The current invention also provides for venting of containers of various sizes, both larger and smaller, such as over the typical eight to nine ounces, or smaller, such as the two-ounce size, used for very premature infants. Since venting is provided, physiological flow occurs, and the infant easily controls the flow, analogous to breastfeeding.

Without venting, only a few drops of liquid can be obtained by the infant, at which time the caregiver must remove the nipple from the intraoral cavity of the infant to allow venting, in order for more liquid to be released from the container. This negative pressure, vacuum-like, unphysiological, harmful cycle has to be repeated many times, over a lengthy period, for the infant to obtain any nutrition. Also, since a very significant vacuum is present, and the flow from the container is almost negligible, no control of the flow is possible. Variations of the shape of the container may be used and the advantages of the current invention are realized. The feeding container may be long and narrow, or short and spherical. The container may have flat sides or utilize rounded edges, or assume any shape or configuration.

In the preferred embodiment, flow is uniquely adjustable by both the infant and caregiver, as enabled by the valve uniquely utilizing a large differential thickness gradient. This gradient provides a proportionally small valve surface area, that ensures that liquid does not exit the feeding system, and air preferentially enters the container. To further enable air to contact the valve, one or more air channels are preferably provided in the periphery of the flange, preferably opposite the air vent, to channel the air coming toward the vent. Air first travels around and over the threads of the container, in the space between container threads and the threads of the collar sealing the nipple onto the container. Thus, the air is routed from the atmosphere outside the container, around the spaces between the threads, through the peripherally located air channel, over the surface of the flange, through the unique air vent, and into the container, to allow truly physiological feeding.

The air thus vents the container and eliminates the vacuum in the container, so the liquid can exit the container on demand, physiologically, for the first time, without requiring any additional components. The entrance of air into the container occurs on-demand, at the rate the liquid is desired by the infant. As the liquid is removed from the container, air spontaneously enters the container, so that no vacuum ever occurs in the container. Liquid is prevented from exiting the feeding aperture of the container, until desired. Also, uniquely, leakage from around the container, the feeding nipple, and the collar joining the two, is prevented.

Providing this unique physics in the prior art of the inventor and the current art container of the inventor provides the flow rate desired by the infant, on-demand, for the first time, through the entire feeding, which emulates breastfeeding. The current art of the inventor provides, for the first time, all of these advantages, without the necessity of any extra components, that have to be manufactured, purchased, cleaned, accounted for, carried, and occasionally replaced.

Additionally, the collar that joins the feeding nipple to the fluid container may be eliminated, to further reduce the components necessary to feed the infant. With this arrangement, the lateral aspect of the flange folds, rolls, or otherwise extends distally from the flange of the nipple onto the superior and lateral aspect of the fluid container, to hold the nipple onto the feeding container. The air vent in this embodiment is located inferiorly to the nipple flange that is in contact with the feeding container opening, and it carries air into the container to prevent any vacuum. The air vent, in this configuration, uniquely utilizes a large differential thickness gradient, as does the preferred embodiment.

Other embodiments utilize the above component with other variably sized containers for other types of fluids. The collar to connect the dispenser to the container may be utilized or not.

In a further embodiment, any number of peripheral flange air channels may be utilized, and various sizes of these may be used. Other embodiments demonstrate one or more large differential thickness gradient air vents of various sizes, in various configurations, placed around the flange. The ratio of air vent area to the channels in the periphery of the flange is variable. Preferably, at least one unique air vent with a large differential thickness gradient utilizing a proportionally small valve surface and at least one peripheral air channel in the periphery of the flange is provided. Preferably, patterned radial slits are provided in the distal aspect of the nipple to further simulate physiological beneficial adjustable feeding, to optimize infant health.

Thus, unhealthy negative pressure and extra parts that can become contaminated, are eliminated, for the first time, by the current invention. Physiological on-demand adjustable flow is provided by eliminating the above vacuum and providing the optimum aperture and preferable radially oriented, controllable slits. Additionally, “Y,” “X,” or other potential apertures slits may be provided for the infant to open and variably control. Constant apertures of various sizes may be provided and both potential and constant apertures may be combined in any combination. Importantly, not only does the unique valve mechanism prevent the maladies cause by the prior art, other than that of the current inventor, but it allows, for the first time, completely adjustable flow by both the caregiver and infant. The variable flow, using the same nipple, is not achievable without complete, automatic, on-demand venting.

Therefore, it is an object of the invention to provide a new and improved controllable flow mechanism, which can be controlled by both the infant and caregiver, in the case of infant feeding bottles; along with a venting mechanism for nursing bottles of infants and for liquids in general, with the unique venting system allowing the unique fully controllable flow by all users.

It is a still further object of this invention to provide a volumetric sized container for use as a nursing bottle, and which incorporates at least one large differential thickness gradient and a proportionally small valve surface area, along with one or more peripheral air channels to further enhance air flow, that prevents leakage during usage when feeding the infant, or during nonusage when the bottle has been set on its base, as during storage, while heating, or when at rest. It is a still further object of this invention to provide a means for feeding that doesn't leak during usage and between usages.

It is an even still further object of this invention is to provide for a structured means within a nursing bottle that provides for full and continuous venting of any pressure or vacuum generated within its container, regardless of usage or nonusage of the subject bottle.

Lastly, it is another object of this invention is to provide for the structure of a wide-rimmed or other sized collar, nipple, or any dispenser, for use with a standard or wide mouth container as structured into a nursing bottle, or other container, which is useful for feeding formula to an infant, incorporating physiological feeding and preventing leakage, while feeding or otherwise dispensing. Various sizes of this invention may be incorporated into containers dispensing other types of fluids.

The present art overcomes the prior art limitations by providing a fully-vented wide rim, or other size, nursing bottle that provides fully adjustable flow, made possible by the full-time, automatic, complete venting, on demand, without any additional components. A nursing bottle, or other container, during usage, is vented to the atmosphere, externally of the bottle, in order to achieve the benefits and results of this embodiment.

These mechanisms allow for fully adjustable flow, along with complete and continuous venting of the container at all times, and also prevents any leakage.

This nursing bottle is uniquely capable of full adjustability of the flow, along with eliminating negative pressure, performing continuously, and on-demand, for any bottle or container. This nursing bottle and its various components may be manufactured from many different materials including but not limited to polymers, low density polyethylene, high density polyethylene, polypropylene, glass, nylon, ferrous and nonferrous metals, their alloys, silicone, and composites. For an example, the feeding container may be made of polypropylene, polycarbonate, polyethylene, or other suitable material. And, the collar for fastening the nipple upon the feeding container may be made of polyethylene, polypropylene, or other material, and the adjacent feeding nipple is preferably made of silicone, or another material.

Variations or modifications to the subject matter of this invention may occur to those skilled in the art upon reviewing the development as described herein. Such variations, if within the scope of this development, are intended to be encompassed within the principles of this invention, as explained herein. The descriptions of the preferred embodiment, in addition to the depiction within the drawings, are set forth for illustrative purposes only.

### BRIEF DESCRIPTION OF DRAWINGS

In referring to the drawings,

FIG. 1 demonstrates one typical size of the container, although any container may be utilized.

FIG. 2 demonstrates another typical size and shape of a typical feeding bottle.

FIG. 3 demonstrates another possible size and shape of a feeding container.

FIG. 4 demonstrates another possible size and shape of the container.

FIG. 5 demonstrates still another variation of the size and shape of the container.

FIG. 6 demonstrates another embodiment of the current invention.

FIG. 7 demonstrates an exploded view of the assembled container, with its components, as noted in FIG. 6.

FIG. 8 demonstrates, an oblique view of the current invention.

FIG. 9 demonstrates a top view of the current invention.

FIG. 10 demonstrates an elevated view of the current invention.

FIG. 11 demonstrates an oblique view of the current invention with a cross-sectional view of both the collar and bottle of the invention.

FIG. 12 demonstrates an elevated view of the current invention.

FIG. 13 demonstrates a cross-sectional view of the invention seen in the elevated view of FIG. 12.

FIG. 14 demonstrates the current invention, in cross-section, showing air entering the container, from outside the container.

FIG. 15 demonstrates an embodiment of the current invention not utilizing a collar and showing the venting mechanism on the lateral aspect of the invention.

FIG. 16 demonstrates the airflow of the embodiment, during usage, of the embodiment of FIG. 15.

FIG. 17 demonstrates an oblique view of the assembled current invention.

FIG. 18 demonstrates a two-piece embodiment of the current invention, in an elevated view.

FIG. 19 demonstrates the two-piece embodiment of FIG. 18, in a cross-sectional view.

FIG. 20 demonstrates the closed position of the air vent mechanism of the current invention.

FIG. 21 demonstrates the open position of the air vent mechanism of the current invention.

FIG. 22 demonstrates the current art valve position.

### DETAILED DESCRIPTION OF THE INVENTION

The present art overcomes the prior art limitations by providing a container with a simultaneous and individually infinitely adjustable flow or flows by one or more users, utilizing and ensured by a necessary venting means utilizing a minimal linear or curvilinear, nonplanar surface area, with leaking prevented by multiple flexible material gradients, allowing for on-demand, vented container flow utilizing only a container, dispenser, and optional joining component. In referring to the drawings, and in particular.

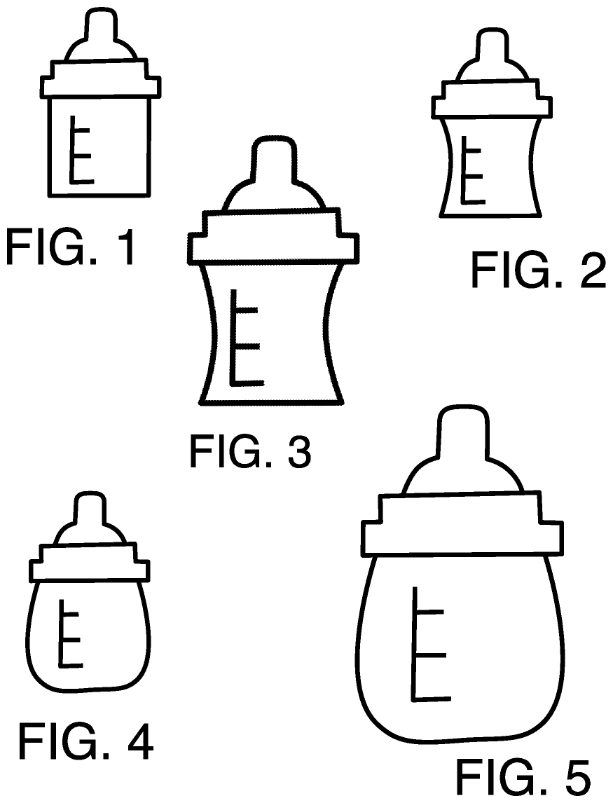

FIGS. 1,2,3,4, and 5 demonstrate various sizes and shapes of the container, demonstrating that various convex, concave and straight surfaces may be seen. The containers have ample volumetric capacity therein. Formula, or another liquid is added to the container, to the desired level, and the feeding dispenser, or nipple, is added to the superior aspect of the container, using a collar to join the two to prevent leakage. The container is then inverted for feeding. Since the system is a closed system, when any liquid is withdrawn, an immediate and forceful vacuum is formed in the container. The liquid container must then be removed from the mouth of the infant, and air enters the container through the liquid aperture in the feeding nipple to relieve the vacuum that has formed. The bottle is then reintroduced to the infant and the above vacuum formation recurs, with the cycle repeating every time the infant feeds. The entire feeding is unhealthy and unphysiological for the infant.

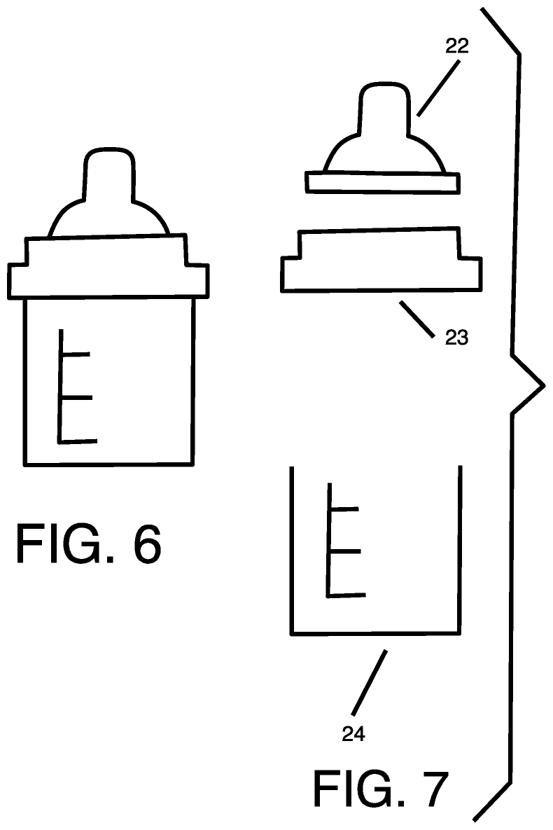

FIG. 6 demonstrates another, assembled, variation of the container.

FIG. 7 demonstrates an exploded view of the assembly of the current invention, as in FIG. 6. The exploded view, FIG. 7, shows the feeding nipple, or dispenser, 22, the attaching collar 23, and the container holding the fluid 24.

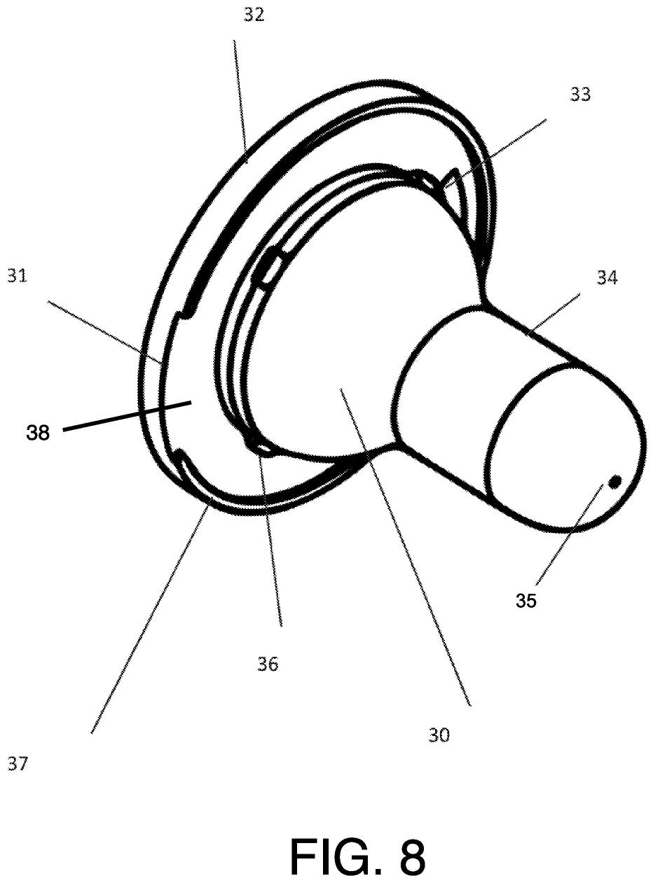

FIG. 8 shows the current invention. The air channel 31 is shown, which receives air from the space between the threads 67 of the container 24, and the threads 69 of collar 23 of the invention. 33 is the venting channel of the invention. 34 is the primary aspect of the nipple that is intraoral. 35 is the aperture of the nipple, where formula exits. 36 is a small tab, that holds the nipple firmly to the collar at all times. 37 is the lateral and superior wall of the invention. The wall ensures a patent air channel is always present on the superior aspect of the flange 38 of the nipple, when the nipple is viewed in the upright position. 30 simulates female breast tissue as it transitions from the intraoral aspect 34 to the flange 38 of the nipple.

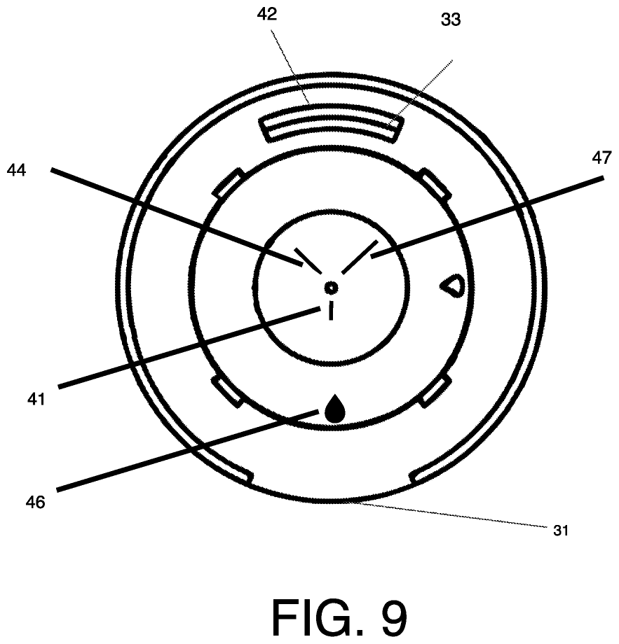

FIG. 9 demonstrates a plan view of the nipple. 42 is the lateral aspect of the air vent of the invention. A cross-sectional elevated view of the air vent is shown in FIG. 13. The air vent 33 is wedge-shaped, with the superior aspect, as viewed in the elevated view as in FIG. 13, wider than the inferior aspect. The inferior aspect, or apex, of the wedge is located at the inferior aspect of the flange 38. Alternatively, the tapering of the wedge ends just prior to the inferior aspect of the flange, such that approximately 1-2 mm of flange material is left toward the inferior aspect of the flange. In that case, a secondary operation is performed to allow the opening of the inferior aspect of the wedge, so that air may enter the container. The cooperation of the air channel, 31, and the vent channel, 33, allow for complete, automatic, physiological, and healthy venting, without leaking, for the first time, without resorting to expensive bags or other parts. 41 is the smaller slit, or potential aperture, for feeding, which the caregiver typically rotates to the 6 o'clock position for slower feeding. The embossed (or debossed) symbol, 46, may be viewed or felt to ascertain the position of the feeding slits, and more than one symbol may be used, in order to position the feeding slits in the desired position, which the infant then manipulates with the tongue, in order to control the flow of fluid from the container. 44 is the medium liquid flow slit, for medium speed feeding, and 47 is the large slit, for the fastest feeding speed. Therefore, the caregiver can present the desired speed to the infant and the infant can manipulate the potential aperture, as desired, with the tongue, in order to control the flow. Also, the potential apertures, or slits, may be presented offset slightly from the 6 o'clock position to allow to an infinite number of flows to be presented to the infant, and since the infant also controls the flow from the aperture, flow control is further enhanced. Liquid is primarily released from the slit in the 6 o'clock position, but the slits may vary in number and size, and liquid will often exit more than one slit at any time during usage. Both the caregiver and infant may completely control the flow, as in breastfeeding. The caregiver may optimally position the container and nipple to the desired position for all of the feeding slits, for the infant to then control the opening of feeding slits. Furthermore, any combination of potential feeding openings (such as slits) and apertures may be combined to optimize feeding, and any combination of these may be presented, and then changed in real-time, by both the caregiver and infant, for the first time. This complete control of flow by the infant is physiological and is what is seen with breastfeeding. Very critically, physics dictates that complete control of the flow is only possible when there is no obstruction to the flow of the fluid. This is only possible when no negative pressure is present in the container, which the current invention uniquely and completely provides for, without using any extra parts or bags. The above detrimental vacuum is present in the great majority of prior art feeding containers, since the claimed venting is not functional. To obtain truly physiological feeding, with no obstruction to flow and with fully adjustable flow, similar to breastfeeding, both the vacuum inside the container must be prevented and variable, controllable apertures and potential apertures must be provided.

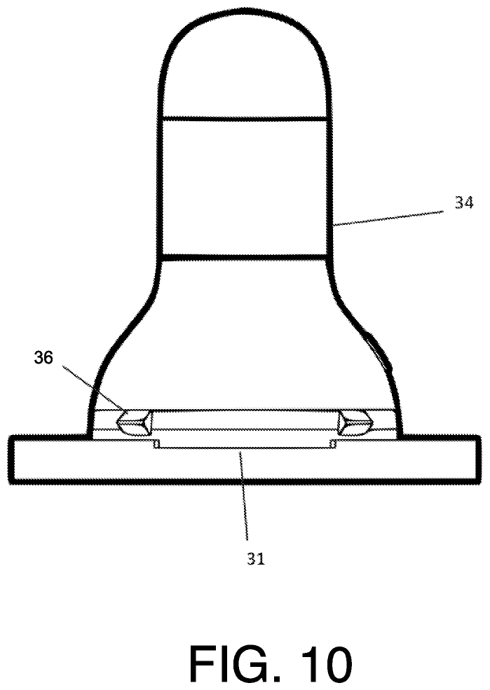

FIG. 10 shows an elevated view of the current invention. Retaining tab 36 is again seen, along with intraoral portion of the nipple 34, and air channel 31.

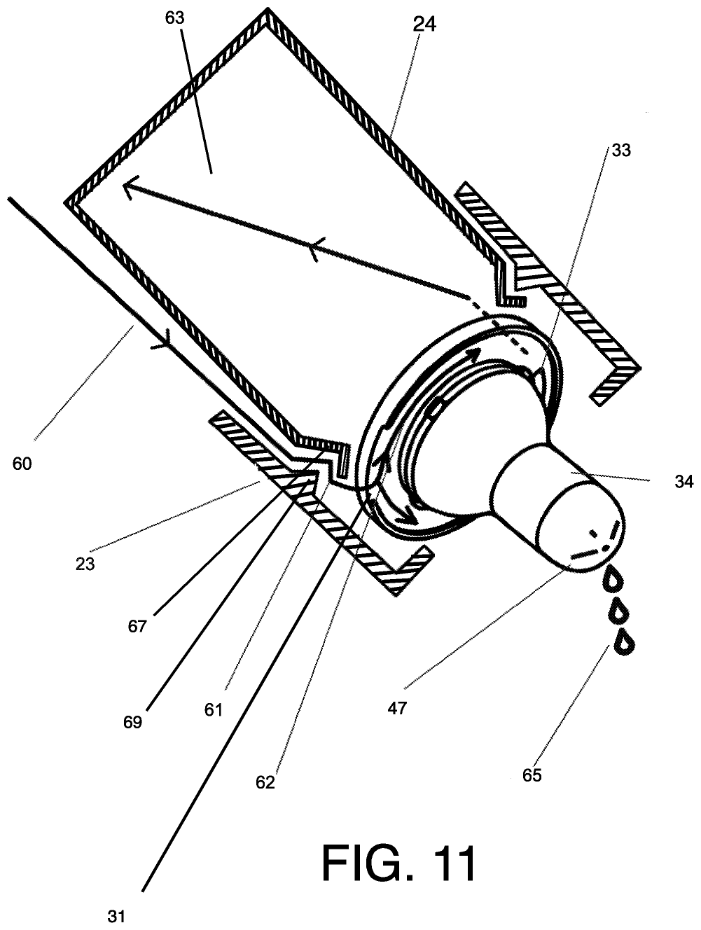

FIG. 11 shows a cross-section of the fluid container and collar, with the current invention shown in an oblique view. Venting channel 33, ensures the necessary venting, by providing a minimal linear or curvilinear, nonplanar surface area, with leaking prevented by multiple flexible material gradients. 62 shows the airflow from the atmosphere 60, between the threads 67 of container 24 and the threads 69 of collar 23 through air channel 31, across the superior aspect of flange 38, through air vent 33, into the interior 63 of container 24. Collar 23 holds nipple 22 onto container 24. Container 24 may be rotated to vary the flow through the various slits 41, 44, and 47, to produce various flows 65. Any number and combinations of potential apertures, such as 41, 44, and 47, and apertures, such as 35, may be supplied. Intraoral section 34 is shown.

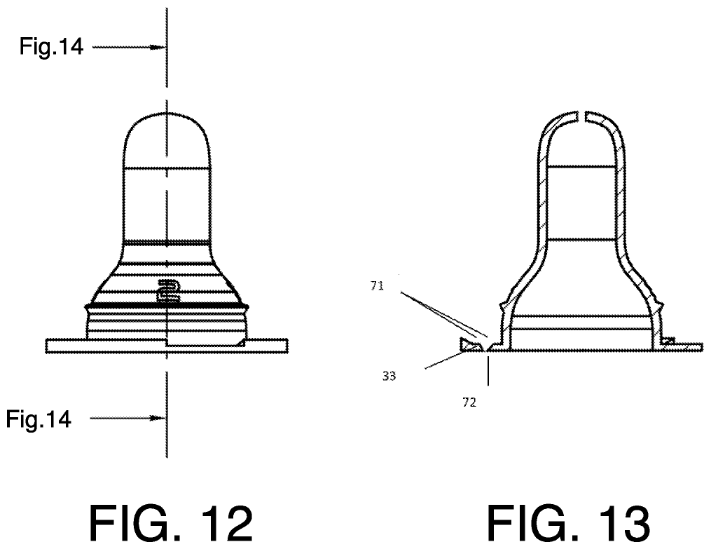

FIG. 12 shows the current invention in an elevated view, with cross-section FIG. 13. FIG. 13 shows the superior wide aspect 71 of air vent 33, and the closed inferior aspect 72 of air vent 33.

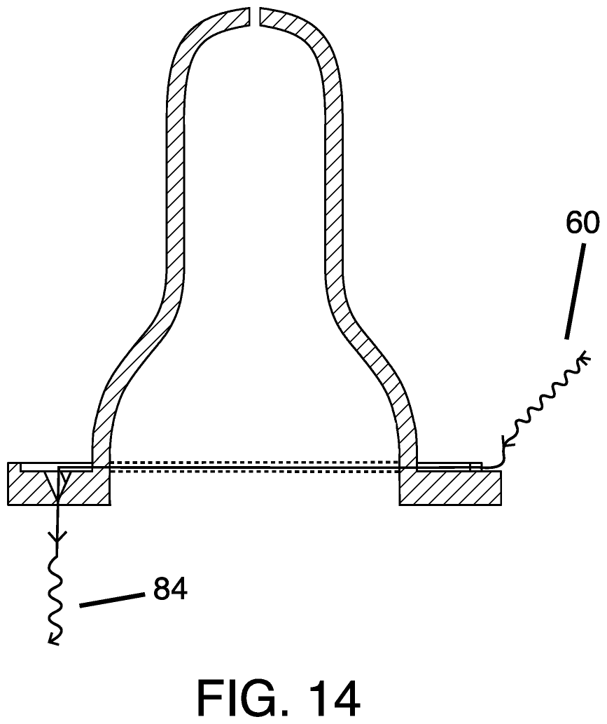

FIG. 14 is a cross-section of nipple 22, with air flow 60 traveling over flange 38 entering the container 24 as at 84.

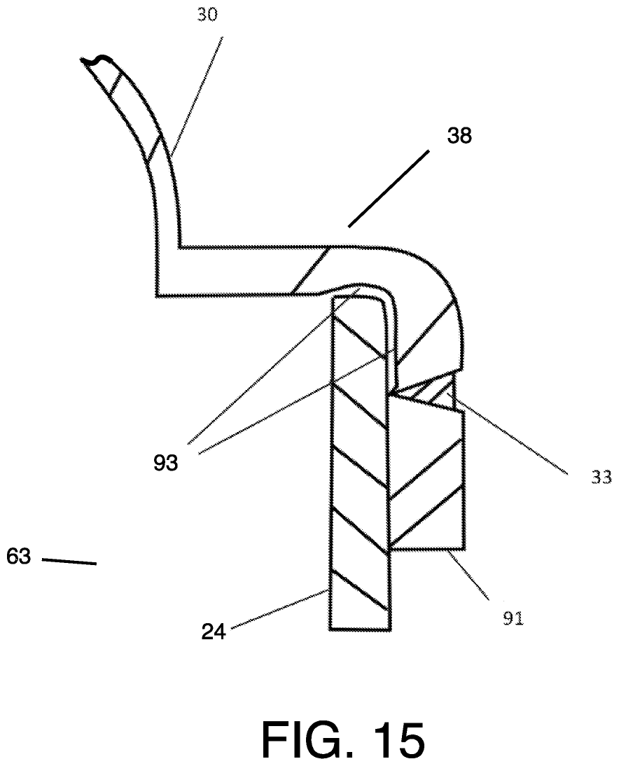

FIG. 15 is a cross-sectional view of an embodiment of the current invention 22, without collar 23, using an extension 91 of nipple flange 38. Air enters at air vent 33 and travels in a modified air channel 93 to enter the interior 63 of container 24. The transition 30 between intraoral portion 34 and flange 38, is shown.

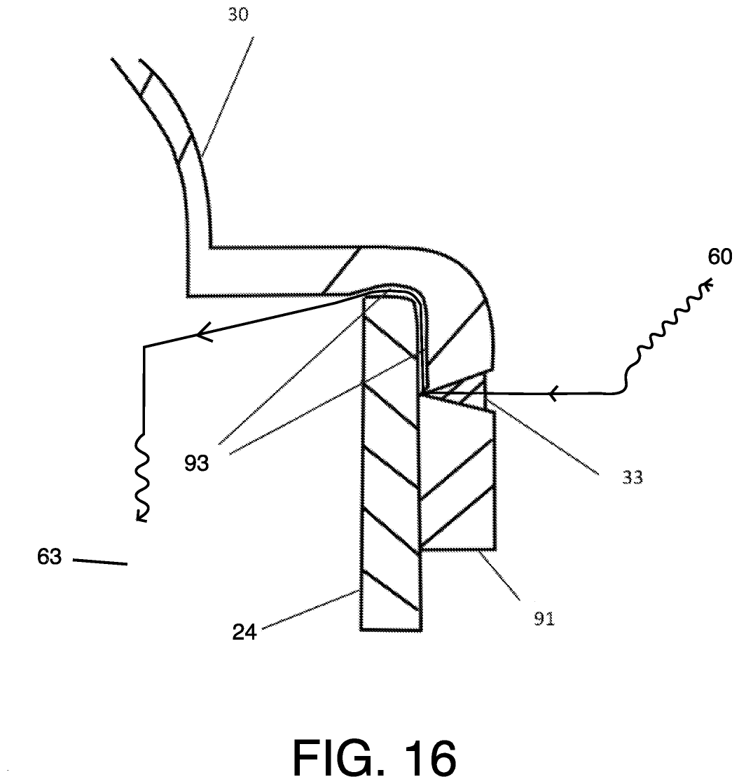

FIG. 16 is a cross-sectional view of the embodiment, shown in FIG. 15, of the current invention, including extension 91, showing atmospheric air 60, entering modified air channel 93, as at 33, into container 24, at 63. Transition 30 is shown.

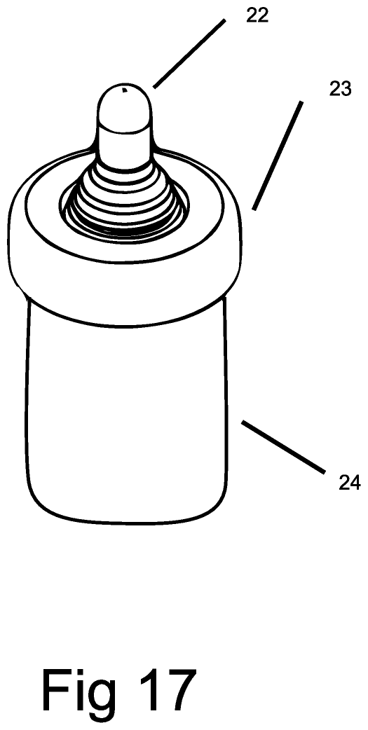

FIG. 17 is an oblique view of the current art, showing collar 23 fastening nipple 22 onto container 24.

FIG. 18 demonstrates an elevated view of the embodiment, as in FIGS. 15 and 16, of the current invention.

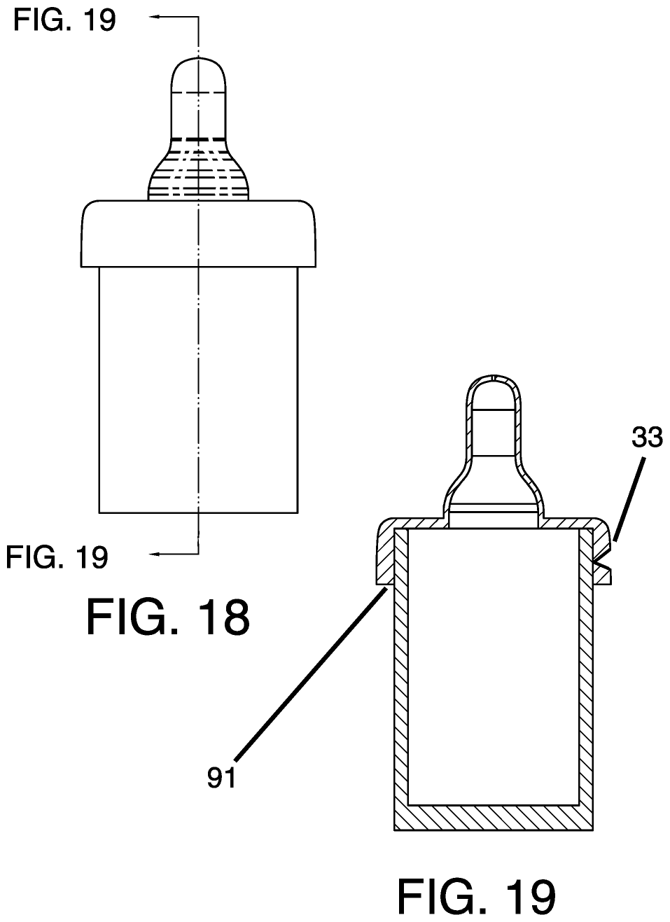

FIG. 19 shows a cross-sectional view of FIG. 18, with lateral flange 91 and air vent 33 in extension 91.

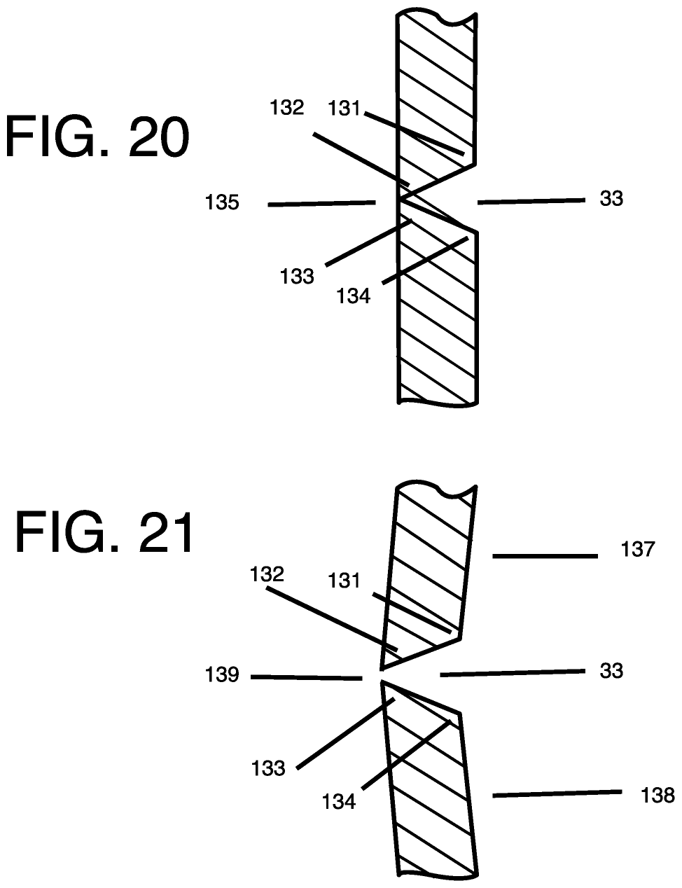

FIGS. 20 and 21 demonstrate cross-sectional views of the venting mechanism of the current invention as at 33, for use in a feeding container or for use in another application. FIG. 20 demonstrates the current invention in the resting position, prior to liquid removal, from the container of the current invention. FIG. 21 demonstrates the position of the current invention, when liquid exits the container, and vacuum formation is prevented. The air vent 33 consists of large material gradients from 131 to 132 and 134 to 133, with both gradients ending prior to 135, such that there is a closure at 135. As less silicone, or other material, is present as the gradient approaches 135, it becomes easier for a vacuum in the interior of the current invention, as at 63, to open a very small aperture, as at 139 in FIG. 21, which uniquely allows air in to prevent vacuum formation, and then prevent liquid leakage, when a vacuum is not present, since it returns to the closed position, as in FIG. 20. The aperture at 139 only opens, as at 139 in FIG. 21, as liquid exits the current invention. The aperture 139 spontaneously closes, as at 135, when no liquid is withdrawn from the container, so as to prevent any liquid leakage from the current invention. Thus, as liquid is withdrawn from the current invention, air may enter the current invention, as in FIG. 14, to prevent vacuum formation, and liquid is prevented from exiting vent channel 33 when no liquid is exiting the current invention at an aperture, such as at 35 or at potential apertures, such as 41, 44 or 47. FIG. 21 demonstrates that aperture formation for venting, as at 139, occurs to prevent vacuum formation in the interior the current invention, during feeding. The aperture at 139, for venting, forms due to the invention gradients 131 to 132, and 134 to 133. The space from 131 to 134 favors aperture formation at 139. The large amount of material at 132 to 133, as compared to that from 131 to 134, favors closure, when liquid is not exiting the current invention and when the current invention is not in use. 137 and 138, as well as the other portions of the nipple 22, form the dispenser in the current invention, and this embodiment, as well as any other embodiments of the current invention, are typically flexible.

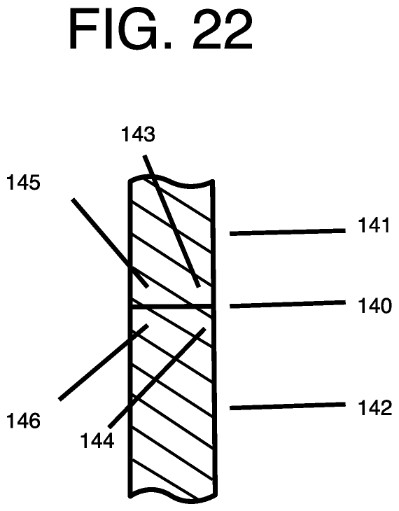

FIG. 22 shows the current art, and demonstrates that no aperture will form from 145 to 146, due the lack of material gradients, from 145 to 143 and from 146 to 144. No aperture will form at 145 to 146, due to the lack of a gradient of material from 143 to 145 and from 146 to 144. 141 and 142 can not flex at 140, as 137 and 138 can at 33, and thus, the current art prevents an aperture formation between 145 and 146.

The present art overcomes the prior art limitations by providing a fully-vented wide rim, or other size, nursing bottle that provides fully adjustable flow, made possible by the full-time, automatic, complete venting, on demand, without any additional components. A nursing bottle, or other container, during usage, is vented to the atmosphere, externally of the bottle, in order to achieve the benefits and results of this embodiment.

These mechanisms allow for fully adjustable flow, along with complete and continuous venting of the container at all times, and also prevents any leakage.

This nursing bottle is uniquely capable of full adjustability of the flow, along with eliminating negative pressure, performing continuously, and on-demand, for any bottle or container. This nursing bottle and its various components may be manufactured from many different materials including but not limited to polymers, low density polyethylene, high density polyethylene, polypropylene, glass, nylon, ferrous and nonferrous metals, their alloys, silicone, and composites. For an example, the feeding container may be made of polypropylene, polycarbonate, polyethylene, or other suitable material. And, the collar for fastening the nipple upon the feeding container may be made of polyethylene, polypropylene, or other material, and the adjacent feeding nipple is preferably made of silicone, or another material.

Variations or modifications to the subject matter of this invention may occur to those skilled in the art upon reviewing the development as described herein. Such variations, if within the scope of this development, are intended to be encompassed within the principles of this invention, as explained herein. The descriptions of the preferred embodiment, in addition to the depiction within the drawings, are set forth for illustrative purposes only.

1. A nursing bottle assembly having a container with a closed bottom end, a top end opposite said bottom end and having an opening therein for receiving liquid into an interior of the container, a rim at the top end also with an inner diameter defining the size of the opening at the top end, a nipple, and a threaded collar to provide sealing between said nipple and said top end while allowing liquid to flow from said container to said nipple, and to provide closure for the opening at the top end, wherein the improvement comprises: said nipple providing venting to said bottle assembly; said nipple having an air channel and a venting channel; said air channel adequately sized to permit adequate air flow to said venting channel; said venting channel adequately sized to permit complete venting of said bottle assembly; said venting channel comprised of a material gradient; said nipple including a means for removal of contents of said assembly.

2. The nursing bottle assembly of claim 1 further comprising: oppositely positioned said air channel and said venting channel.

3. The nursing bottle of claim 1 further comprising: a variable number of air channels and a variable number of venting channels.

4. The nursing bottle assembly of claim 1 further comprising: a variable number of said air channels and a variable number of said venting channels, with said air channels oppositely positioned from said venting channels.

5. The nursing bottle assembly of claim 4 further comprising: any number of constant apertures in said nipple.

6. The nursing bottle assembly of claim 4 further comprising: any number of variable apertures in said nipple.

7. The nursing bottle assembly of claim 4 further comprising: a variable number of constant apertures and a variable number of variable apertures in said nipple.

8. The nursing bottle assembly of claim 4 further comprising: a variable number of constant patterned apertures and a variable number of patterned variable apertures in said nipple.

9. A nursing bottle assembly having a container with a closed bottom end, a top end opposite said bottom end and having an opening therein for receiving liquid into an interior of the container, a rim at the top end also with an inner diameter defining the size of the opening at the top end and a nipple, wherein the improvement comprises: said nipple providing venting to said bottle assembly, said nipple having a venting channel; said venting channel adequately sized to permit complete venting of said bottle assembly; said venting channel comprised of a material gradient; said nipple including a means for removal of contents of said assembly.

10. The nursing bottle of claim 9 further comprising: a variable number of venting channels.

11. The nursing bottle assembly of claim 10 further comprising: any number of constant apertures in said nipple.

12. The nursing bottle assembly of claim 10 further comprising: any number of variable apertures in said nipple.

13. The nursing bottle assembly of claim 10 further comprising: a variable number of constant apertures and a variable number of patterned apertures in said nipple.

14. The nursing bottle assembly of claim 10 further comprising: a variable number of constant patterned apertures and a variable number of patterned variable apertures in said nipple.

15. A container assembly having a container with a closed bottom end, a top end opposite said bottom end and having an opening therein for receiving liquid into an interior of the container, a rim at the top end also with an inner diameter defining the size of the opening at the top end, a dispenser, and a threaded collar to provide sealing between said dispenser and said top end while allowing liquid to flow from said container to said dispenser, and to provide closure for the opening at the top end, wherein the improvement comprises: said dispenser providing venting to said container assembly; said dispenser having an air channel and a venting channel; said air channel adequately sized to permit adequate air flow to said venting channel; said venting channel adequately sized to permit complete venting of said container assembly; said venting channel comprised of a material gradient; said dispenser including a means for removal of contents of said assembly.

16. The container assembly of claim 15 further comprising: oppositely positioned said air channel and said venting channel.

17. The container assembly of claim 15 further comprising: a variable number of air channels and a variable number of venting channels.

18. The container assembly of claim 15 further comprising: a variable number of said air channels and a variable number of said venting channels, with said air channels oppositely positioned from said venting channels.

19. The container assembly of claim 18 further comprising: any number of constant apertures in said dispenser.

20. The container assembly of claim 18 further comprising: any number of variable apertures in said dispenser.

21. The container assembly of claim 18 further comprising: a variable number of constant apertures and a variable number of variable apertures in said dispenser.

22. The container assembly of claim 18 further comprising: a variable number of constant patterned apertures and a variable number of patterned variable apertures in said dispenser.

23. The container assembly of claim 22 further comprising: no said collar with said dispenser directly applied to said container.

24. A nipple for a nursing bottle of the type having an upwardly extending portion through which formula flows during a feeding, and an integral flange portion that connects onto the top of the bottle during usage, wherein the upward portion having variable slits some of differing length to allow for varying the flow rate of formula from the bottle during nursing, and said integral flange incorporating structure to facilitate the internal venting of the bottle during a feeding performance; said upward extending portion having at least a pair of different length slits approximately located on opposite sides of the nipple such that as the user pivots the bottle with the nipple inserted into the infant's mouth delivering a supply of formula at a rate of fast or slow flow to the infant; and the nipple structure providing a passage along one side edge of the nipple flange to allow access of air to the said flange, and a wedge vent provided through an approximate opposite surface of the said flange to vent any developed vacuum formed within the bottle during formula consumption so that the rate of delivery of formula flow from the nursing bottle can be varied while the bottle is simultaneously vented during application.
